(19) United States
(12) Patent Application Publication
(10) Pub. No.: US 2026/0125924 A1
(43) Pub. Date: May 7, 2026

(54) TRANSPARENT ROOF TENT

(71) Applicant: SHENZHEN YANGNING AUTO ACCESSORY CO., LTD, SHENZHEN (CN)

(72) Inventor: SHIAWDAR SHAUN YUE, SHENZHEN (CN)

(21) Appl. No.: 19/027,769

(22) Filed: Jan. 17, 2025

(30) Foreign Application Priority Data
Nov. 1, 2024 (CN) 202422676518.9

(51) Int. Cl. E04H 15/06; B60P 3/38; E04H 15/48; E04H 15/54

(52) U.S. Cl. CPC E04H 15/06; B60P 3/38; E04H 15/48; E04H 15/54

(57) ABSTRACT

A transparent roof tent is disclosed. The transparent roof tent includes a mounting base, a top cover, and a support rod assembly. The mounting base is used to be mounted on a top of a vehicle. One end of the mounting base is connected to one end of the top cover by a hinge. Two ends of the support rod assembly are respectively connected to the mounting base and the top cover to support the top cover. The top cover includes a top frame and a top plate. The top frame is annular. Edges of the top plate are connected to inner sides of the top frame. The top plate is made of a transparent hard material.

### CROSS-REFERENCE TO RELATED APPLICATIONS

This application claims the priority and benefit of Chinese patent application number CN202422676518.9, titled “Transparent Roof Tent” and filed Nov. 1, 2024 with China National Intellectual Property Administration, the entire contents of which are incorporated herein by reference.

### TECHNICAL FIELD

This application relates to the technical field of tents, and more particularly relates to a transparent roof tent.

### BACKGROUND

As a new type of outdoor camping, rooftop tents have been increasingly favored by self-driving tourists. Tents may be set up on the ground. But firstly, they are troublesome to set up and take down, which is time-consuming and laborious; secondly, the ground moisture and rainwater may invade, and insects and other animals may invade, which is not safe; thirdly, the ground mat used is thin and not comfortable. The roof tent, however, is installed on the roof of the vehicle, which is ventilated, waterproof, insect-proof, and thus safe. It can also be opened and closed quickly, thereby saving time and effort.

For the time being, the top of the roof tent may be opaque, and most of them may be designed with windows on the tent fabric on both sides, which results in that the user cannot see the outside sky when lying in the tent when using the roof tent, thus affecting the user experience.

### SUMMARY

In view of the above, it is therefore one purpose of this application to provide a transparent roof tent, so that users can see the outside sky inside the tent, improving the user experience.

The present application discloses a transparent roof tent. The transparent roof tent includes a mounting base, a top cover, and a support rod assembly. The mounting base is used to be installed on a top of a vehicle. One end of the mounting base is connected to one end of the top cover by a hinge. Two ends of the support rod assembly are respectively connected to the mounting base and the top cover to support the top cover. The top cover includes a top frame and a top plate. The top frame is annular. Edges of the top plate are connected to inner sides of the top frame. The top plate is made of a transparent hard material.

In some embodiments, the top plate is made of a transparent acrylic material.

In some embodiments, the top plate is an integrated flat plate structure, and wherein the edges of the top plate are bonded to the inner sides of the top frame.

In some embodiments, the top cover further includes a plurality of top bars, which are arranged in parallel on a side of the top plate facing towards the mounting base and abut against the top plate. Two ends of each top bar are respectively connected to two opposite sides of the top frame. The top bar is made of a transparent hard material.

In some embodiments, the top cover further includes a one-way perspective film, which is attached to a surface of the top plate and used to transmit light from an inside of the transparent roof tent to an outside, and to block light from the outside to the inside of the transparent roof tent.

In some embodiments, the top cover further includes a heat insulation film attached to a side of the top plate facing the mounting base, the heat insulation film being a transparent film.

In some embodiments, the top cover further includes a buffer film, which is attached to a side of the top plate facing away from the mounting base, the buffer film being an elastic transparent film.

In some embodiments, the buffer film is made of polyphthalamide.

In some embodiments, the mounting base and the top cover are both rectangular, each having two opposite long-axis sides and two opposite short-axis sides. The two short-axis sides of the mounting base are defined as a mounting base front end and a mounting base rear end, respectively, and the two short-axis sides of the top cover are defined as a top cover front end and a top cover rear end, respectively. The mounting base rear end and the top cover rear end are connected by a hinge. The support rod assembly includes two air springs. Each long-axis side of the mounting base and the corresponding long-axis side of the top cover are connected by a respective one of the air springs.

In some embodiments, the transparent roof tent further comprises a U-shaped support frame. Both ends of the U-shaped support frame are each connected to the mounting base front end through a respective hinge. The U-shaped support frame is operative to rotate around the mounting base front end.

In some embodiments, both sides of the U-shaped support frame are retractable.

In some embodiments, the U-shaped support frame includes a U-shaped tube, two sleeve tubes, and two locking pieces. One end of each of the two sleeve tubes is connected to the mounting base front end through a hinged locking portion. The other ends of the two sleeve tubes are respectively connected to the two ends of the U-shaped tube. The two locking pieces are respectively arranged on the two sleeve tubes to control a depth of the two ends of the U-shaped tube in the sleeve tubes.

In some embodiments, the hinged locking portion includes a fixing base, a rotating arm, a latch, and a shaft pin. The fixing base has a bottom plate and two opposite side walls. The bottom plate of the fixing base is fixed to the mounting base front end. The side walls of the fixing base are arranged opposite to the long-axis side of the fixing base. The rotating arm is a C-shaped structure. A first end of the rotating arm is connected to the two side walls of the fixing base through a shaft pin. A slide slot is further defined in one side wall of the fixing base. A socket is further defined in the other side wall of the fixing base. The latch passes through the slide slot and the first end of the rotating arm to be fitted with the socket. A second end of the rotating arm is connected to the sleeve tubes.

In some embodiments, at least two sockets are defined in the other side wall of the fixing base, and the at least two sockets are arranged along a trajectory of the slide slot.

In some embodiments, the transparent roof tent further includes a plurality of locking buckles, which are respectively distributed on the two long-axis sides and the front end of the roof tent. Each of the plurality of locking buckle comprises a locking core and a locking hook. The locking core is fixed to an outside of the mounting base. The locking hook is fixed to an outside of the top cover. The locking core and the locking hook are operative to be engaged with each other so as to be locked together.

In some embodiments, the roof tent further includes a tent fabric, which is connected to the edges of the mounting base and the edges of the top cover. The U-shaped support frame is used to support the tent fabric. The tent fabric is arranged between the top cover and the mounting base, and the tent fabric forms a rolling curtain region corresponding to an area of the top plate. The fabric located in the rolling curtain area is connected to other fabrics in the tent fabric by a zipper.

In some embodiments, the mounting base includes a bottom frame, at least two mounting bars, and a plurality of cross bars. The bottom frame is annular and arranged around the plurality of cross bars. The bottom frame includes two opposite long bottom frame bars, two opposite short bottom frame bars, and four bottom wrapping corners. The long bottom frame bar and the short bottom frame bar that are adjacent to each other are connected by one respective bottom wrapping corner. The plurality of cross bars are arranged in parallel, and the two ends of each cross bar are respectively connected to the two long bottom frame bars. Each mounting bar is disposed on a side of the plurality of cross bars facing away from the top cover and is connected to the plurality of cross bars. The cross bars, the long bottom frame bars, and the short bottom frame bars are each made of a carbon fiber material.

In some embodiments, the top frame includes two opposite long top frame bars, two opposite short top frame bars, and four top wrapping corners. Each long top frame bar and the respective short top frame bar that are adjacent to each other are connected by a respective one of the top wrapping corners. The long top frame bars and the short top frame bars are both made of aluminum alloy.

The present application further discloses a transparent roof tent. The transparent roof tent includes a mounting base, a top cover, and a support rod assembly. The mounting base is used to be installed on a top of a vehicle. One end of the mounting base is connected to one end of the top cover through a hinge. The two ends of the support rod assembly are respectively connected to the mounting base and the top cover, and are used to support the top cover. The top cover includes a top frame, a top plate, and a plurality of top bars. The top frame is annular. The top plate is an integrated flat plate structure. The edges of the top plate are connected to the inner sides of the top frame. The plurality of top bars are arranged in parallel on the side of the top plate facing the mounting base, and abut against the top plate. The two ends of each top bar are respectively connected to the opposite sides of the top frame. The top plate and the top bars are both made of transparent hard materials. The top cover further includes a heat insulation film and a buffer film. The heat insulation film is attached to the side of the top plate facing the mounting base, and the heat insulation film is a transparent film. The buffer film is attached to the side of the top plate facing away from the mounting base, and the buffer film is an elastic transparent film.

The beneficial effects of the present application are as follows. In the present application, the top plate of the roof tent is made of a transparent hard material, so that the user can see the external environment through the top plate in the tent. Since the mounting base and the top cover in the transparent roof tent are connected by a hinge at one end, the top plate of the transparent roof tent is tilted after the transparent roof tent is unfolded. The user can see not only the sky but also the surrounding environment through the top plate in the tent, with a wider viewing angle and a better user experience. In addition, only the top plate in the top cover of the roof tent is transparent. The top frame surrounds and protects the top plate to prevent the top plate from being hit and avoids the need for designing connection structures on the top plate, which effectively protects the top plate and thus increases the service life of the transparent roof tent.

### BRIEF DESCRIPTION OF DRAWINGS

The accompanying drawings are used to provide a further understanding of the embodiments according to the present application, and constitute a part of the specification. They are used to illustrate the embodiments according to the present application, and explain the principles of the present application in conjunction with the text description. Apparently, the drawings in the following description merely represent some embodiments of the present disclosure, and for those having ordinary skill in the art, other drawings may also be obtained based on these drawings without investing creative. In the drawings:

FIG. 1 is a schematic diagram of a roof tent provided in an embodiment of the present application when unfolded.

FIG. 2 is a schematic diagram of another roof tent provided in an embodiment of the present application when unfolded.

FIG. 3 is a schematic diagram of the roof tent in FIG. 2 when folded.

FIG. 4 is a schematic diagram of a top cover provided in an embodiment of the present application.

FIG. 5 is a schematic diagram of a top cover with a one-way perspective film provided in an embodiment of the present application.

FIG. 6 is a schematic diagram of a top cover with a heat insulation film provided in an embodiment of the present application.

FIG. 7 is a schematic diagram of a top cover with a buffer film provided in an embodiment of the present application.

FIG. 8 is a schematic diagram of a top cover with a heat insulation film and a buffer film provided in an embodiment of the present application.

FIG. 9 is a schematic diagram of another roof tent provided in an embodiment of the present application when unfolded.

FIG. 10 is a schematic diagram of a hinged locking portion provided in an embodiment of the present application.

FIG. 11 is a schematic diagram of a mounting base provided in an embodiment of the present application.

### DETAILED DESCRIPTION OF EMBODIMENTS

It should be understood that the terms used herein, the specific structures and functional details disclosed therein are merely representative for describing some specific embodiments, but the present application can be implemented in many alternative forms and should not be construed as being limited to only these embodiments described herein.

In addition, unless otherwise clearly specified and defined, the terms “installed on”, “disposed on”, “arranged on”, and “connected to” should be understood in a broad sense. For example, it may be a fixed connection, a detachable connection, or an integral connection; it may be a mechanical connection or an electrical connection; it may be a direct connection or an indirect connection through an intermediate medium, or it may be internal communication between two elements. For those of ordinary skill in the art, the specific meanings of the above terms as used in the present application can be understood depending on specific contexts.

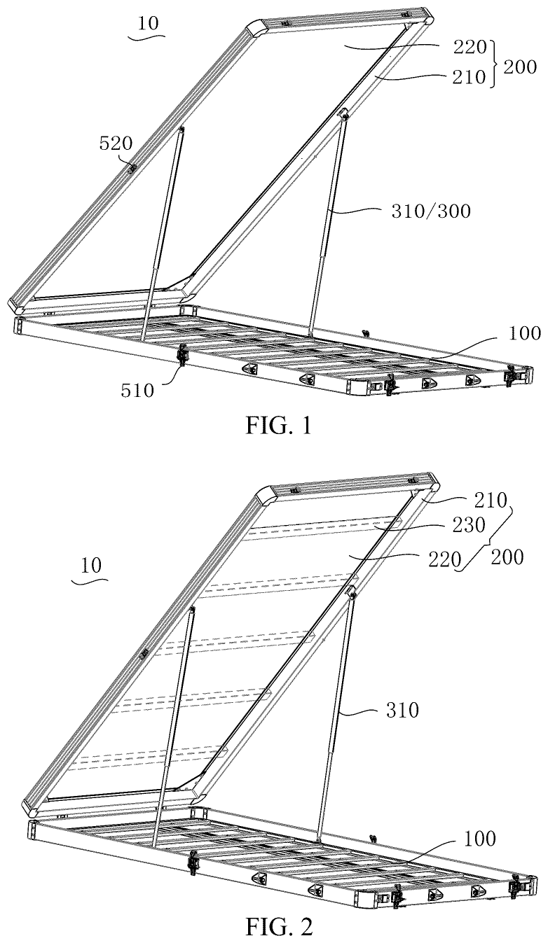

As shown in FIG. 1, one embodiment of the present application provides a transparent roof tent 10. The transparent roof tent 10 includes a mounting base 100, a top cover 200, and a support rod assembly 300. The mounting base 100 is used to be installed on a top of a vehicle. One end of the mounting base 100 is connected to one end of the top cover 200 by a hinge. Two ends of the support rod assembly 300 are respectively connected to the mounting base 100 and the top cover 200, where the support rod assembly 300 is used to support the top cover 200. The top cover 200 includes a top frame 210 and a top plate 220. The top frame 210 is annular in shape. Edges of the top plate 220 are connected to the inner sides of the top frame 210. The top plate 220 is made of a transparent hard material.

In the present application, the top plate 220 of the roof tent is made of a transparent hard material, so that the user can see the external environment through the top plate 220 in the tent. Since the mounting base 100 and the top cover 200 in the transparent roof tent 10 are connected by a hinge at one end, the front end of the top plate 220 is turned upward after the transparent roof tent 10 is unfolded, so the top plate 220 is tilted. Thus, the user can see not only the sky but also the surrounding environment through the top plate 220 in the tent, with a wider viewing angle and a better user experience. In addition, only the top plate 220 of the top cover 200 of the roof tent is transparent. The top frame 210 surrounds and protects the top plate 220, prevents the top plate 220 from being hit, and avoids directly designing a connection structure on the top plate 220, effectively protecting the top plate 220, thereby improving the service life of the transparent roof tent 10.

In the embodiments of the present application, the support rod assembly 300 is composed of two air springs 310. The two air springs 310 are respectively located on both sides of the transparent roof tent 10, connecting the two sides of the mounting base 100 and the two sides of the top cover 200. When the front end of the transparent roof tent 10 is opened so that the front end of the top cover 200 is turned around the rear end of the top cover 200, the two air springs 310 will automatically support the top cover 200, making it easier for the user to unfold the transparent roof tent 10.

In the embodiment of the present application, the top plate 220 may be made of a transparent acrylic material. Due to the material properties of acrylic, the transparency, hardness, and weather resistance of the top plate 220 are well guaranteed. It is not as brittle as glass, not as expensive as the transparent ABS material, and not as easy to deform as the transparent PET material. Therefore, the use of transparent acrylic material to make the top plate 220 can reduce the production cost, increase the service life of the top plate 220, and ensure the use effect of the transparent roof tent 10.

Furthermore, the top plate 220 in the embodiments of the present application may be an integrated flat plate structure. That is, the top plate 220 is a whole, and the top plate 220 is flat, and the thickness is uniform everywhere, so there will be no problems such as light refraction and reflection due to unevenness, so that the user can see the natural external environment.

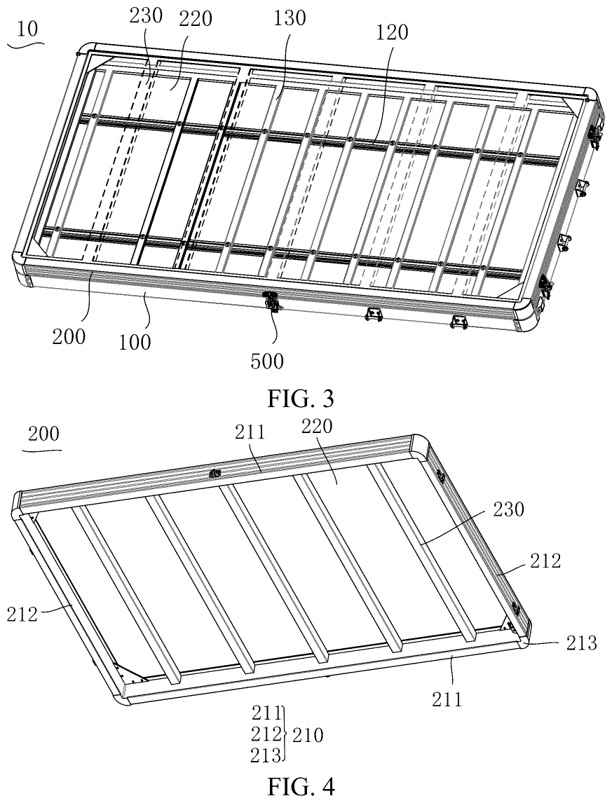

As shown in FIG. 2 and FIG. 3, in some embodiments, the top cover 200 further includes a plurality of top bars 230. The plurality of top bars 230 are arranged in parallel on the side of the top plate 220 facing the mounting base 100, abutting against the top plate 220, and the two ends of each top bar 230 are respectively connected to the opposite sides of the top frame 210. The top bar 230 may be made of a transparent hard material.

Since the top plate 220 in the transparent roof tent 10 is relatively large in size and the top plate 220 is an integral structure, top bars 230 may be added below the top plate 220 to support the top plate 220 to prevent the top plate 220 from being deformed by external forces such as pressing.

The top bars 230 may also be made of the transparent acrylic material, the same material as the top plate 220, to prevent the light from being refracted after passing through the top plate 220 and the top bar 230 thus resulting in a difference between the scene seen from the top bar 230 area and the scene seen from the top plate 220.

In the embodiments of the present application, the top frame 210 may be made of an aluminum alloy material, a hard plastic, or a carbon fiber material. The four side edges of the top plate 220 may be connected to the inner sides of the top frame 210 by bonding and/or plugging.

As shown in FIG. 4, as a specific example, the top frame 210 includes two opposite long top frame bars 211, two opposite short top frame bars 212, and four top wrapping corners 213. The long top frame bar 211 and the short top frame bar 212 that are adjacent to each other are connected by one corresponding top wrapping corner 213. Specifically, both ends of the top wrapping corner 213 are hollowed out, and the long top frame bar 211 and the short top frame bar 212 are respectively inserted into the two ends of the top wrapping corner 213. The long top frame bars 211 and the short top frame bars 212 are both made of an aluminum alloy.

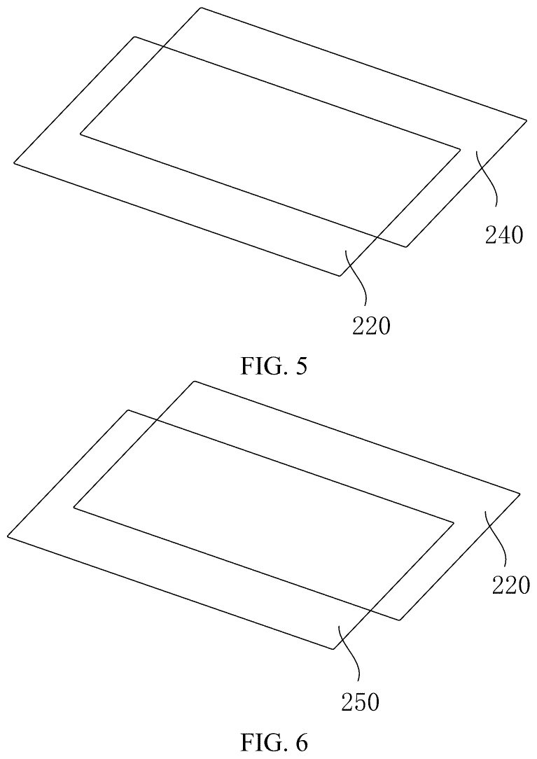

As shown in FIG. 5, in some embodiments, the top cover 200 further includes a one-way perspective film 240. The one-way perspective film 240 may be attached to a surface of the top plate 220, and it may be attached to the outer surface of the top plate 220, or may be attached to the inner surface of the top plate 220. The one-way perspective film 240 is used to allow transmission of light passing from the inside of the transparent roof tent 10 to the outside, and to block light passing from the outside to the inside of the transparent roof tent 10. Through this design, the privacy in the tent can be guaranteed without affecting the user's viewing of the outside world in the tent.

As shown in FIG. 6, in some embodiments, the top cover 200 further includes a heat insulation film 250. The heat insulation film 250 is attached to the side of the top plate 220 facing the mounting base 100, and the heat insulation film 250 is a transparent film. Without affecting the transmittance of the top plate 220, the heat insulation film 250 may insulate the external heat and prevent the transparent roof tent 10 from overheating.

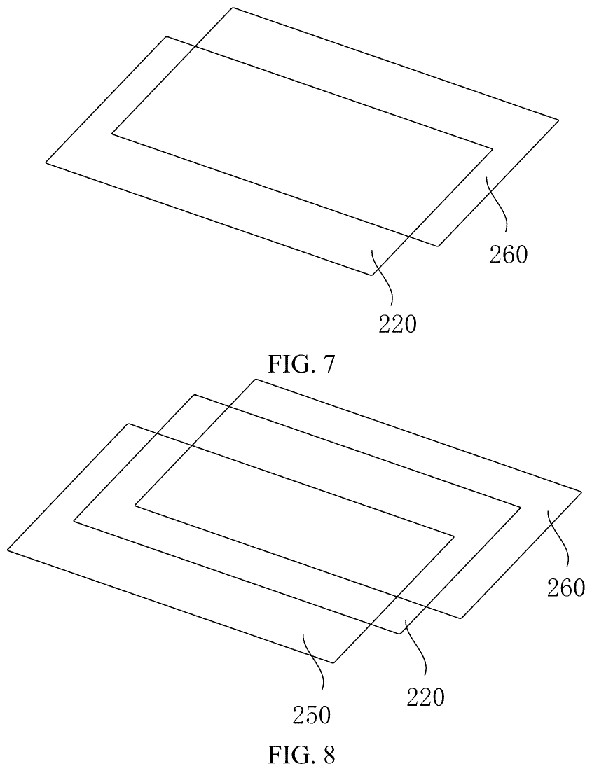

As shown in FIG. 7, in some embodiments, the top cover 200 further includes a buffer film 260. The buffer film 260 is attached to a side of the top plate 220 facing away from the mounting base 100, and the buffer film 260 is an elastic transparent film. Without affecting the transmittance of the top plate 220, the buffer film 260 can prevent the top plate from cracking or deforming due to external impact or collision. The buffer film 260 may be made of polyphthalamide (PPA), specifically PPA5.

As shown in FIG. 8, in some embodiments, there is disposed a heat insulation film 250 on the back of the top plate 220. That is, the heat insulation film 250 is attached to the side of the top plate 220 facing the mounting base 100. Furthermore, the front of the top plate 220 has a buffer film 260, and the buffer film 260 is attached to the side of the top plate 220 facing away from the mounting base 100, so that the top plate 220 has both buffering and heat insulation effects.

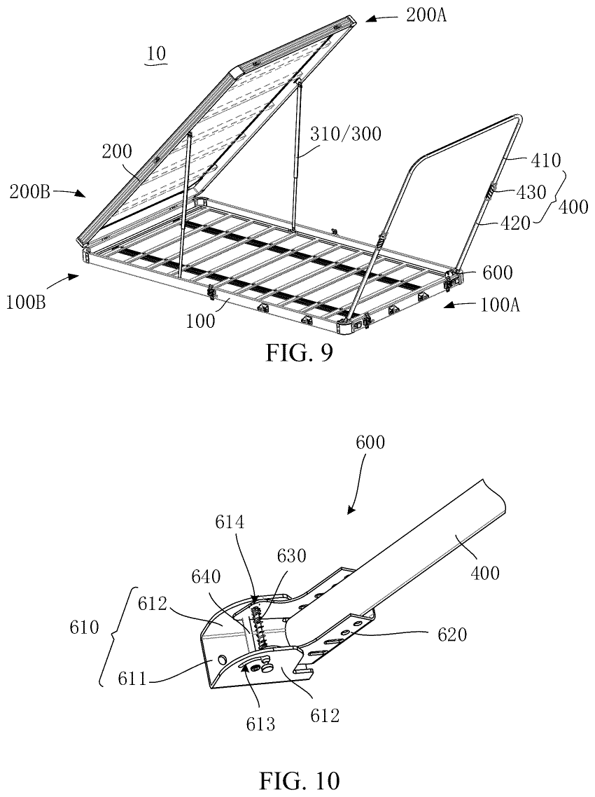

As shown in FIG. 9, in some embodiments, the mounting base 100 and the top cover 200 are both rectangular, each having two opposite long-axis sides and two opposite short-axis sides. The two short-axis sides in the mounting base 100 are defined as the mounting base front end 100A and the mounting base rear end 100B respectively. The two short-axis sides of the top cover 200 are defined as the top cover front end 200A and the top cover rear end 200B. The mounting base rear end 100B and the top cover rear end 200B are connected by a hinge. The support rod assembly 300 includes two air springs 310. Each long-axis side of the mounting base 100 and the corresponding long-axis side of the top cover 200 are connected by one respective air spring 310.

Furthermore, the transparent roof tent 10 further includes a U-shaped support frame 400. Both ends of the U-shaped support frame 400 are each connected to the mounting base front end 100A by a hinge. The U-shaped support frame 400 rotates around the mounting base front end 100A.

The roof tent further includes a tent fabric (not shown in the figure). The tent fabric is connected to the edges of the mounting base 100 and the edges of the top cover 200, and wraps up the space between the U-shaped support frame 400, the mounting base 100, and the top cover 200. The U-shaped support frame 400 is used to support the tent fabric, so that there is a larger space in the tent.

Furthermore, the two sides of the U-shaped support frame 400 are retractable, and the height of the U-shaped support frame 400 may be adjusted as needed, and the rotational angle of the U-shaped support frame 400 may be adjusted depending on the hinge design between the U-shaped support frame 400 and the mounting base 100, so that the front end of the tent fabric can adapt to different needs.

The U-shaped support frame 400 includes a U-shaped tube 410, two sleeve tubes 420, and two locking pieces 430. One end of each of the two sleeve tubes 420 is connected to the mounting base front end 100A, specifically to the inner side of the mounting base 100, through a hinged locking portion 500. The other ends of the two sleeve tubes 420 are respectively connected to the two ends of the U-shaped tube 410 through insertion or plugging. The two locking pieces 430 are respectively arranged on the two sleeve tubes 420 to control the depth of the two ends of the U-shaped tube 410 in the sleeve tubes 420. Specifically, when the locking pieces 430 are opened, the ends of the U-shaped tube 410 are not subjected to a pressing force, and the ends of the U-shaped tube 410 can be adjusted to extend or contract in the sleeve tubes 420. When the locking pieces 430 are closed, the ends of the U-shaped tube 410 are pressed, so that the ends of the U-shaped tube 410 cannot move in the sleeve tubes 420.

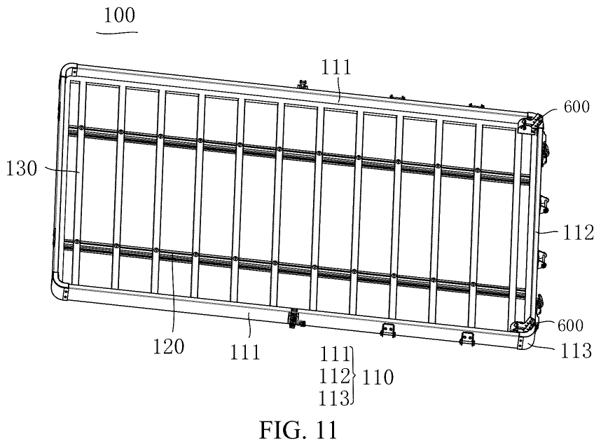

As shown in FIG. 10, the hinged locking portion 600 includes a fixing base 610, a rotating arm 620, a latch 630, and a shaft pin 640. The fixing base 610 has a bottom plate 611 and two opposite side walls 612. The bottom plate 611 of the fixing base 610 is fixed to the mounting base front end 100A. The side walls 612 of the fixing base 610 are arranged opposite to each other straddling the long axis of the fixing base 610.

The rotating arm 620 is a C-shaped structure, a V-shaped structure, or an L-shaped structure. The first end of the rotating arm 620 is connected to the two side walls 612 of the fixing base 610 through the shaft pin 640. A slide slot 613 is further defined in one side wall 612 of the fixing base 610. A socket 614 is further defined in the other side wall 612 of the fixing base 610. The latch 630 passes through the slide slot 613 and the first end of the rotating arm 620 to be fitted with the socket 614. The second end of the rotating arm 620 is connected to the corresponding end of the respective sleeve tube 420.

The length direction of the shaft pin 640 is the same as that of the cross bar 130. The first end of the rotating arm 620 is connected to the two side walls 612 of the fixing base 610 through the shaft pin 640, so that the second end of the rotating arm 620 and the U-shaped support frame 400 can rotate around the shaft pin 640. In addition, the slide slot 613 is defined in one side wall 612 of the fixing base 610, and the socket 614 is defined in the other side wall 612. When the latch 630 is inserted into the slide slot 613 and the socket 614, the latch 630 locks the rotating arm 620 to prevent the rotating arm 620 from rotating and affecting the stability of the U-shaped support frame 400 when in use.

Furthermore, at least two of the sockets 614 may be defined in the other side wall 612 of the fixing base 610, and the at least two sockets 614 are disposed along the trajectory of the slide slot 513. Through this design, the angle of the rotating arm 620 may be adjusted by inserting the latch 630 into different sockets 614, thereby achieving angular adjustment of the U-shaped support frame 400 and meeting more usage requirements.

Furthermore, the latch 630 in the embodiments of the present application is an elastic latch sleeved with a spring. The latch 630 can be disengaged from the socket 614 by simply pulling the head of the latch 630 outward, and then the rotation of the rotating arm 620 can be controlled. After rotating arm 620 is rotated to a predetermined position, the latch 630 can be releases. There is no need to remove the latch 630 when adjusting rotating arm 620, so that the product is more convenient to use.

In some embodiments, the tent fabric is not only arranged between the top cover 200 and the mounting base 100, but also arranged on the side of the top cover 200 facing the mounting base 100, that is, covering the top plate 220. Furthermore, the area of the tent fabric corresponding to the top plate 220 may form a rolling curtain area. The fabric located in the rolling curtain area may be connected to other fabrics in the tent fabric by a zipper or other detachable means. In this way, when there is no need to see the outside environment or to protect the privacy inside the tent, the fabric of the rolling curtain area can be pulled up through the zipper to cover the top plate 220. When it is needed to see the outside environment, the fabric of the rolling curtain area can be opened and rolled up through the zipper to reveal the entire transparent top plate 220.

As shown in FIG. 11, the mounting base 100 includes a bottom frame 110, at least two mounting bars 120, and a plurality of cross bars 130. The bottom frame 110 is annular and is arranged around the plurality of cross bars 130. The bottom frame 110 includes two opposite long bottom frame bars 111, two opposite short bottom frame bars 112, and four bottom wrapping corners 113. The long bottom frame bar 111 and the short bottom frame bar that are adjacent to each other 112 are connected by a corresponding bottom wrapping corner 113. The plurality of cross bars 130 are arranged in parallel. The two ends of each of the cross bar 130 are respectively connected to the two long bottom frame bars 111. The mounting bars 120 are disposed on the side of the cross bar 130 facing away from the top cover 200 and are connected to the cross bars 130. The cross bars 130, the long bottom frame bars 111, and the short bottom frame bars 112 are all made of the carbon fiber material.

Of course, the mounting base 100 further includes at least two mounting bars 120. The mounting bars 120 are disposed on the side of the cross bars 130 facing away from the top cover 200 and connected to the cross bars 130. The mounting bars 120 are used to be connected to the top of the vehicle.

In the embodiments of the present application, the top cover 200 has a top plate 220 made of acrylic material, and the mounting base 100 has a cross bar 130, a long bottom frame bar 111, and a short bottom frame bar 112 made of carbon fiber material. Compared with the current roof tents whose main frame is made of aluminum alloy, the overall weight of the transparent roof tent 10 in the embodiments of the present application is lighter, which is convenient for the installation and transportation of the transparent roof tent 10, and is also conducive to saving fuel consumption during the driving process of the vehicle and reducing the use cost.

In addition, as shown in FIG. 1 and FIG. 3, the roof tent further includes a plurality of locking buckles 500. The plurality of locking buckles 500 are respectively distributed on the two long-axis sides and the front end of the transparent roof tent 10. Specifically, two locking buckles 500 may be arranged on one long-axis side of the transparent roof tent 10, and one locking buckle 500 may be designed at the front end of the transparent roof tent 10.

The locking buckle 500 includes a locking core 510 and a locking hook 520. The locking core 510 is fixed to the outside of the mounting base 100. The locking hook 520 is fixed to the outside of the top cover 200. The locking core 510 and the locking hook 520 are operative to be engaged for locking In the embodiment of the present application, by arranging a locking buckle 500 on the transparent roof tent 10, the top cover 200 can be locked during the folding stage of the transparent roof tent 10 to prevent the top cover 200 from springing open after being folded.

The foregoing is a further detailed description of the present application with reference to some specific optional implementations, but it cannot be determined that the specific implementation of the present application is limited to these implementations. For those having ordinary skill in the technical field to which the present application pertains, several deductions or substitutions may be made without departing from the concept of the present application, and all these deductions or substitutions should be regarded as falling in the scope of protection of the present application.

What is claimed is:

1. A transparent roof tent, comprising a mounting base, a top cover, and a support rod assembly; wherein the mounting base is used to be mounted on a top of a vehicle, wherein one end of the mounting base is connected to one end of the top cover through a hinge; wherein two ends of the support rod assembly are respectively connected to the mounting base and the top cover, the support rod assembly being used to support the top cover;
wherein the top cover comprises a top frame and a top plate, wherein the top frame is annular, wherein edges of the top plate are connected to inner sides of the top frame, and wherein the top plate is made of a transparent hard material.

2. The transparent roof tent as recited in claim 1, wherein the top plate is made of a transparent acrylic material.

3. The transparent roof tent as recited in claim 1, wherein the top plate is of an integrated flat plate structure, and wherein the edges of the top plate are bonded to the inner sides of the top frame.

4. The transparent roof tent as recited in claim 1, wherein the top cover further comprises a plurality of top bars, which are arranged in parallel on a side of the top plate facing towards the mounting base and abut against the top plate, and wherein two ends of each of the plurality of top bars are respectively connected to two opposite sides of the top frame;
wherein the top bar is made of a transparent hard material.

5. The transparent roof tent as recited in claim 1, wherein the top cover further comprises a one-way perspective film attached to a surface of the top plate and used to allow light to be transmitted from an inside of the transparent roof tent to an outside, and to block light transmitted from the outside to the inside of the transparent roof tent.

6. The transparent roof tent as recited in claim 1, wherein the top cover further comprises a heat insulation film attached to a side of the top plate facing the mounting base, and wherein the heat insulation film is a transparent film.

7. The transparent roof tent as recited in claim 1, wherein the top cover further comprises a buffer film attached to a side of the top plate facing away from the mounting base, and wherein the buffer film is an elastic transparent film.

8. The transparent roof tent as recited in claim 7, wherein the buffer film is made of polyphthalamide.

9. The transparent roof tent as recited in claim 1, wherein the mounting base and the top cover are each rectangular, each having two opposite long-axis sides and two opposite short-axis sides, wherein the two short-axis sides of the mounting base are defined as a mounting base front end and a mounting base rear end, respectively, and wherein the two short-axis sides of the top cover are defined as a top cover front end and a top cover rear end, respectively;
wherein the mounting base rear end and the top cover rear end are connected to each other by a hinge, wherein the support rod assembly comprises two air springs, wherein each of the two long-axis sides of the mounting base is connected to the corresponding long-axis side of the top cover by a respective one of the two air springs.

10. The transparent roof tent as recited in claim 9, further comprising a U-shaped support frame, wherein both ends of the U-shaped support frame are each connected to the mounting base front end through a respective hinge, and wherein the U-shaped support frame is operative to rotate around the mounting base front end.

11. The transparent roof tent as recited in claim 10, wherein both sides of the U-shaped support frame are retractable.

12. The transparent roof tent as recited in claim 11, wherein, wherein the U-shaped support frame comprises a U-shaped tube, two sleeve tubes, and two locking pieces; wherein one end of each of the two sleeve tubes is connected to the mounting base front end through a hinged locking portion, wherein two other ends of the two sleeve tubes are respectively connected to the two ends of the U-shaped tube, and wherein the two locking pieces are respectively arranged on the two sleeve tubes to control a depth of the two ends of the U-shaped tube in the two sleeve tubes.

13. The transparent roof tent as recited in claim 12, wherein each hinged locking portion comprises a fixing base, a rotating arm, a latch, and a shaft pin; wherein the fixing base has a bottom plate and two opposite side walls; wherein the bottom plate of the fixing base is fixed to the mounting base front end; wherein the two side walls of the fixing base are arranged opposite to each other about a long-axis side of the fixing base; wherein the rotating arm is of a C-shaped structure, wherein a first end of the rotating arm is connected to the two side walls of the fixing base through a shaft pin; wherein there is further defined a slide slot in one side wall of the fixing base, and there is further defined a socket in another side wall of the fixing base; wherein the latch passes through the slide slot and the first end of the rotating arm to be fitted with the socket; wherein a second end of the rotating arm is connected to a respective one of the two sleeve tubes.

14. The transparent roof tent as recited in claim 13, wherein there are defined at least two sockets in the other side wall of the fixing base, and wherein the at least two sockets are arranged along a trajectory of the slide slot.

15. The transparent roof tent as recited in claim 9, further comprising a plurality of locking buckles, which are respectively distributed on the two long-axis sides and the front end of the roof tent; wherein each of the plurality of locking buckles comprises a locking core and a locking hook, wherein the locking core is fixed to an outside of the mounting base, wherein the locking hook is fixed to an outside of the top cover, wherein the locking core and the locking hook are operative to be engaged with each other so as to be locked up together.

16. The transparent roof tent as recited in claim 10, further comprising a tent fabric connected to edges of the mounting base and edges of the top cover; wherein the U-shaped support frame is used to support the tent fabric; wherein the tent fabric is arranged between the top cover and the mounting base; wherein and the tent fabric forms a rolling curtain region corresponding to an area of the top plate, wherein the fabric disposed in the rolling curtain area is connected to other fabric pieces in the tent fabric by a zipper.

17. The transparent roof tent as recited in claim 1, wherein the mounting base comprises a bottom frame, at least two mounting bars, and a plurality of cross bars; wherein the bottom frame is annular and arranged around the plurality of cross bars; wherein the bottom frame comprises two opposite long bottom frame bars, two opposite short bottom frame bars, and four bottom wrapping corners; wherein each long bottom frame bar and the respective short bottom frame bar that are adjacent to each other are connected by a respective one of the four bottom wrapping corners; wherein the plurality of cross bars are arranged in parallel, and wherein two ends of each of the plurality of cross bars are respectively connected to the two long bottom frame bars; wherein each of the at least two mounting bars is disposed on a side of the plurality of cross bars facing away from the top cover and is connected to the plurality of cross bars; wherein the plurality of cross bars, the two long bottom frame bars, and the two short bottom frame bars are each made of a carbon fiber material.

18. The transparent roof tent as recited in claim 1, wherein the top frame comprises two opposite long top frame bars, two opposite short top frame bars, and four top wrapping corners; wherein each long top frame bar and the respective short top frame bar that are adjacent to each other are connected by a respective one of the four top wrapping corners;
wherein the two long top frame bars and the two short top frame bars are each made of an aluminum alloy.

19. A transparent roof tent, comprising a mounting base, a top cover, and a support rod assembly; wherein the mounting base is used to be mounted on a top of a vehicle, wherein one end of the mounting base is connected to one end of the top cover by a hinge, wherein two ends of the support rod assembly are respectively connected to the mounting base and the top cover to support the top cover;
wherein the top cover comprises a top frame, a top plate, and a plurality of top bars; wherein the top frame is annular, wherein the top plate is of an integrated flat plate structure, wherein edges of the top plate are connected to inner sides of the top frame, wherein the plurality of top bars are arranged in parallel on a side of the top plate facing the mounting base and abut against the top plate, wherein the two ends of each of the plurality of top bars are respectively connected to two opposite sides of the top frame; wherein the top plate and the plurality of top bars are each made of a transparent hard material;
wherein the top cover further comprises a heat insulation film and a buffer film, wherein the heat insulation film is attached to a side of the top plate facing the mounting base, and is a transparent film; and wherein the buffer film is attached to a side of the top plate facing away from the mounting base, and is an elastic transparent film.
